(19) United States
(12) Patent Application Publication
(10) Pub. No.: US 2003/0143030 A1
(43) Pub. Date: Jul. 31, 2003

(54) Method of treating contaminants in an in situ environment

(76) Inventor: Richard Greenberg, Fair Lawn, NJ (US)

Correspondence Address: WATOV & KIPNES, P.C., P.O. Box 247, Princeton Junction, NJ, 08550, US

(21) Appl. No.: 10/059,605

(22) Filed: Jan. 30, 2002

(51) Int. Cl. B09C 1/08

(52) U.S. Cl. 405/128.75

(57) ABSTRACT

A method of treating contaminants in an in situ environment by the administration to the in situ environment of a rapidly acting contaminant treating composition and an effective amount of a metal permanganate.

### FIELD OF THE INVENTION

The present invention is directed to methods for converting contaminants contained in soil and/or groundwater to non-contaminating or harmless compounds. The methods include treatment of the contaminants with a rapidly acting contaminant treating composition as well as a composition containing an effective amount of a metal permanganate which provides extended treatment after the rapidly acting contaminant treating composition has been spent.

### BACKGROUND OF THE INVENTION

The treatment of contaminated soils and groundwater has gained increased attention over the past few years because of uncontrolled hazardous waste disposal sites. It is well documented that the most common means of site remediation has been excavation and landfill disposal. While these procedures remove contaminants, they are extremely costly and in some cases difficult if not impossible to perform.

More recently, research has focused on the conversion of contaminants contained in soil and groundwater based on the development of on-site and in situ treatment technologies. One such treatment has been the incineration of contaminated soils. The disadvantage of this system is in the possible formation of harmful by-products including polychlorinated dibenzo-p-dioxins (PCDD) and polychlorinated dibenzofurans (PCDF).

In situ biological soil treatment and groundwater treatment is another such system that has been reviewed in recent years. So-called bioremediation systems, however, have limited utility for treating waste components that are biorefractory or toxic to microorganisms.

Such bioremediation systems were the first to investigate the practical and efficient injection of hydrogen peroxide into groundwater and/or soils. These investigations revealed that the overriding issue affecting the use of hydrogen peroxide in situ was the instability of the hydrogen peroxide downgradient from the injection point. The presence of minerals and enzymes such as catalase and peroxidase in the subsurface can catalyze the disproportionation of hydrogen peroxide near the injection point. As a result, there is a rapid evolution and loss of molecular oxygen. Because the rapid loss of oxygen is detrimental efforts have been made to use stabilizers as well as biological nutrients to slow or eliminate the loss of oxygen.

During early biological studies in the 1980's, some investigators recognized the potential for competing reactions, such as the direct oxidation of the substrate by hydrogen peroxide. Certain researchers also hypothesized that an unwanted in situ Fenton's-like reaction under native conditions in the soil was reducing yields of oxygen through the production of hydroxyl radicals. Such a mechanism of contaminant reduction was not unexpected, since Fenton's-type systems have been used in ex situ systems to treat soil and groundwater contamination.

Other investigators concomitantly extended the use of Fenton's-type systems to the remediation of in situ soil systems. These studies attempted to correlate various parameters such as hydrogen peroxide, iron, and phosphate concentrations, pH, and temperature with the efficiency of remediation.

As with the bioremedial systems, in situ Fenton's systems were often limited by instability of the hydrogen peroxide in situ and by the lack of spatial and temporal control in the formation of the oxidizing agent (i.e. hydroxyl radical) from the hydrogen peroxide. In particular, aggressive/violent reactions often occurred at or near the point where the source of the oxidizing agent (the hydrogen peroxide) and the catalyst were injected. As a consequence, a significant amount of reagents including the source of the oxidizing agent (hydrogen peroxide) was wasted because activity was confined to a very limited area around the injection point. In addition, these in situ Fenton's systems often required the aggressive adjustment of groundwater pH to acidic conditions, which is not desirable in a minimally invasive treatment system. Finally, such systems also resulted in the mineralization of the subsurface, resulting in impermeable soil and groundwater phases due to the deleterious effects of the reagents on the subsurface soils.

U.S. Pat. No. 5,741,427 describes the complexing of a ligand donor with a metal catalyst to moderate the catalytic turnover rate of the metal catalyst. It is indicated that the preferred metal catalysts include metal salts, iron oxyhydroxides, iron chelates, manganese oxyhydroxides and combinations thereof, and the ligand donors generally comprise acids, salts of acids, and combinations thereof. The described reaction product complex of the metal catalyst and ligand donor moderates the catalytic turnover rate for a longer time and for a further distance from the injection point to provide enhanced spatial and temporal control in the formation of the oxidizing agent (i.e. hydroxyl radical). Although the system described in the '427 Patent works well, the reaction product complex is somewhat acidic with a typical pH in the range of 3 to 5, which is undesirable from the standpoint of proper environmental remediation as well as regulatory review.

If a Fenton reagent system is not altered to provide the necessary enhanced spatial and temporal control of the formation of the oxidizing agent, then an alternative approach is to provide continuous or periodic treatment in order to effectively remove a sufficient amount of contaminants to meet EPA standards. The periodic or continuous treatment protocol is expensive because of the need to have equipment and manpower at the injection site over an extended period of time.

It would be a significant advantage in the art of removing contaminants from soil and/or groundwater to provide a system by which the contaminants are removed without having to periodically and/or continuously treat the in situ environment. It would be a further advantage in the art to provide a contaminant removing system by which the treating composition is capable of removing contaminants over a short period of time as well as an extended period of time without engaging in continuous and/or periodic treatment protocols.

It would be a further significant advantage in the art to provide a system which avoids the aggressive adjustment of groundwater pH to acidic conditions.

It would be a still further advantage in the art if there was provided a method of treating contaminants in an in situ environment through the employment of a rapidly acting contaminant treating composition in combination with a composition which can remain in the soil for a long period of time and treat contaminants after the rapidly acting contaminant treating composition has been spent.

### SUMMARY OF THE INVENTION

The present invention is generally directed to a method of treating contaminants in an in situ environment which provides for the treatment of contaminants over a short period of time as well as the treatment of contaminants over an extended period of time without continuous or periodic treatment protocols.

In the particular embodiment of the present invention, there is provided a method of treating contaminants in an in situ environment comprising:

a) treating the in situ environment with a rapidly acting contaminant treating composition; and

b) treating the in situ environment with an effective amount of a metal permanganate.

The treatment with the metal permanganate can be simultaneously with the treatment afforded by the rapidly acting contaminant treating composition or sequentially.

### DETAILED DESCRIPTION OF THE INVENTION

The present invention is generally directed to methods for removing contaminants from soil and/or groundwater by converting the same to harmless by-products. Such contaminants typically arise from petroleum storage tank spills or from intentional or accidental discharge of liquid hydrocarbons including, but not limited to, gasoline, fuel oils, benzene, toluene, ethylbenzene, xylenes, (BTX) naphthalene, pesticides, herbicides, and other organic compounds; lubricants, chlorinated solvents, including polychlorinated biphenyls (PCBs), and pentachlorophenol (PCP); cyanides, and the like. The list of contaminants provided herein is exemplary. It should be understood, however, that other contaminants capable of being oxidized into harmless compounds, such as carbon dioxide in water, is within the purview of the present invention. In accordance with the present invention, the method for remediation of a contaminated environment in situ is performed by providing a rapidly acting contaminant treating composition (e.g. a Fenton's reagent) to the in situ environment together with or sequentially an effective amount of a metal permanganate. The metal permanganate is preferably selected from sodium permanganate and potassium permanganate. The metal permanganate composition provides a long term contaminate treating effect on the in situ environment and therefore serves to continue the treatment of the soil and/or groundwater long after the rapidly acting contaminant treating composition has been spent. Because of the combination of a rapidly acting contaminant treating composition with the metal permanganate composition, the amount of metal permanganate used does not leave unacceptable residual amounts of manganese oxide in the subsurface.

As used herein, the term “rapidly acting contaminant treating composition” means any contaminant treating composition effective for treating soil and/or groundwater for the conversion of contaminants to harmless by-products which occurs within a relatively short period of time typically up to a few days. Such compositions are typically highly reactive and therefore are prone to rapid reaction with contaminants contained in the soil and/or groundwater.

While any such rapidly acting contaminant treating composition is within the scope of the present invention, preferred rapidly acting contaminant treating compositions are generally referred to as Fenton reagent systems. Such systems typically comprise a source of an oxidizing agent and a metallic catalyst composition alone or in combination of conventional additives such as pH adjusting compounds, stabilizers, and the like. Such Fenton reagent systems employing a source of an oxidizing agent and a metal catalyst composition enables temporal and spatial control of the oxidation process for the rapidly reacting system. The Fenton reagent system is typically injected into a specific area of the in situ environment such as, but not limited to, the capillary fringe. The capillary fringe is a portion of the contamination site which lies just above the water table. Destruction of contamination in the capillary fringe is preferred because it prevents the contamination which is often adsorbed in the capillary fringe from serving as a continuing source of groundwater and soil contamination.

The sources of the oxidizing agent which may be employed in the present invention are those that typically generate free radicals (e.g. hydroxyl radicals) and include peroxides such as hydrogen peroxide, calcium peroxide, sodium peroxide and the like. Calcium peroxide generates hydroxyl radicals under acidic conditions in the presence of iron (II) salts. Calcium peroxide is very slightly soluble in water and is generally more expensive than hydrogen peroxide. Sodium peroxide has been found to behave in a manner similar to calcium peroxide and can be used as well.

Another source of the oxidizing agent is ozone. Ozone has previously been used as a disinfectant and in more recent applications to oxidize refractory organic contaminants. Ozone is taught as a source of oxidizing agent for soil and groundwater contamination in Richard J. Watts et al. (U.S. Pat. No. 5,741,427) incorporated herein by reference.

The peroxides and ozone, as exemplary hydroxyl radical producing compounds, can be used alone or in combination with each other. What is essential is that the source of the oxidizing agent be capable of generating hydroxyl radicals in sufficient quantity to convert existing contaminants (e.g. hydrocarbons) to harmless compounds (e.g. carbon dioxide and water vapor).

Fenton reagent systems also employ a metal catalyst composition which may include a metal catalyst alone or in combination with other materials such as a ligand donor. A metal catalyst composition is typically selected from metal salts, iron oxyhydrides, iron chelates, manganese oxyhydrides and combinations thereof. Preferred metal catalysts include iron (II) salts, iron (III) salts, iron (II) chelates, iron (III) chelates and combinations thereof.

A preferred form of the rapidly acting contaminant treating composition includes a stabilized source of oxidizing agent. In order to stabilize the oxidizing agents mentioned above, it is often desirable to add a stabilizer selected from the group consisting of acids, salts, and mixtures thereof. Acids include phosphoric acid, acetic acid, citric acid, carbonic acid, boric acid, silicic acid and the like. The preferred acid is phosphoric acid. Preferred salts include monopotassium phosphate, silicates such as sodium silicate, citrates such as sodium citrate, acetates such as sodium acetate and the like.

A typical range for the molar ratio of the source of oxidizing agent to the metal catalyst system is from about 5 to 20:1.

Stock solutions containing a metal permanganate typically have a concentration of up to the metal about 40% by weight of permanganate. By way of example, a potassium permanganate solution will typically have a concentration of from about 1 to 6% by weight while the concentration of a sodium permanganate solution will generally be higher.

The amount of metal permanganate solution will generally be in a range that can deliver a field level amount of the metal permanganate in the range of from about 100 to 1,000 ppm.

The administration of the rapidly acting contaminant treating composition and the metal permanganate is typically concurrent treatment. In some instances, it may be desirable to first add the rapidly acting contaminant treating composition to the in situ environment followed shortly thereafter by the metal permanganate composition, typically within a few days of the administration of the former composition.

### EXAMPLE I

Five 150 ml vessels were provided with chlorinated volatile organic compounds (VOC's). Each vessel was equipped with a sealed aluminum cap containing rubber septa to facilitate injection of a reagent in accordance with the present invention or a control.

The first vessel was provided with deionized water only. The second vessel was provided with Fenton's reagent only; namely hydrogen peroxide stabilized with monopotassium phosphate and ferrous sulfate. The third vessel was charged only with 500 ppm of sodium permanganate.

In accordance with the present invention, vessel No. 4 was charged at the same time with the same Fenton's reagent provided to vessel No. 2 and the potassium permanganate provided to vessel No. 3. Vessel No. 5 was provided sequentially with the same Fenton's reagent and sodium permanganate provided to vessel No. 4.

A four hour time limit was placed on the reaction in vessel No. 2, while a 72 hour time limit was placed on vessel Nos. 3-5 due to the slower reagent rates associated with sodium permanganate. Quenching of the Fenton reagent reaction was performed in a routine manner using Catalase after 4 hours.

Samples of each of the vessels were collected in 40 ml vials, preserved, and the vials were sent to an independent laboratory and measured for VOC's using EPA method 624. The results are shown in Table 1.

As shown in Table 1, the treatment of the present invention employing Fenton's reagent and sodium permanganate either simultaneously or sequentially reduced target VOC's to a significantly greater extent than either of the reactants individually.

TABLE 1

| Vessel No. | | Treatment 1 | Treatment 2 | Treatment 3 | Treatment 4 | Treatment 5 |
|---|---|---|---|---|---|---|
| Description | | Deionized water | Fenton's reagent only | Sodium Permanganate | Sodium | Fenton's reagent and |
| | | | | | Permanganate and | quench after 4-hours. |
| | | | | | Fenton's reagent | Then inject Sodium |
| | | | | | simultaneously | Permanganate and |
| | | | | | | quench after 72 hours. |
| Volatile Organic | Units | | | | | |
| Compounds | | | | | | |
| Chloroform | μg/L | ND<400 | 27.9 | 18.2 | 17.9 | 16.6 |
| Carbon Tetrachloride | μg/L | ND<930 | 12 | 14.2 | 14.2 | 12.6 |
| 1,2-Dichloroethane | μg/L | ND<280 | 1.11 | 1.4 | 1.18 | 1.16 |
| Trichloroethene | μg/L | 78500 | 10440 D | 57300 D | ND<0.54 | ND<0.54 |
| Bromodichloromethane | μg/L | ND<200 | 0.573 | 0.495 | ND<0.20 | ND<0.20 |
| Toluene | μg/L | ND<250 | ND<0.25 | 2.14 | ND<0.25 | ND<0.25 |
| 1,1,2-Trichloroethane | μg/L | ND<230 | 8.56 | 9.9 | 8.97 | 8.21 |
| Tetrachloroethene | μg/L | ND<650 | 3.34 | 8.06 | ND<0.65 | ND<0.65 |
| Bromoform | μg/L | ND<340 | ND<0.34 | ND<0.34 | 1.25 | ND<0.34 |
| 1,3-Dichlorobenzene | | ND<140 | ND<0.14 | ND<0.14 | ND<0.14 | ND<0.14 |
| Total target VOCs⁺ | μg/L | 78500 | 10493.5 | 57354.4 | 43.5 | 38.6 |
| Total TIC's | μg/L | ND | ND | ND | 14.8 | 12.2 |
| Reduction (Target | — | 0% | 86.75 | 26.9% | 99.9% | 99.9% |
| VOCs)* | | | | | | |

Note:
ND = Analyzed for but not detected at the method detection limit (MDL) indicated.
VOCs = Volatile organic compounds
TIC's = Tentatively Identified Compounds or non-target compounds
D = Results from diluted sample analysis
μg/L = micrograms per liter
*= Percent reduction calculations are relative to control sample and assume ND values as equivalent to zero.

What is claimed:

1. A method of treating contaminants in an in situ environment comprising:
treating the in situ environment with a rapidly acting contaminant treating composition; and
treating the in situ environment concurrently or sequentially with an effective amount of a metal permanganate composition.

2. The method of claim 1 wherein the metal permanganate is selected from the group consisting of sodium permanganate and potassium permanganate.

3. The method of claim 1 wherein the metal permanganate composition is in the form of a solution having a concentration of up to about 40% by weight.

4. The method of claim 3 wherein metal permanganate composition contains potassium permanganate at a concentration of from about 1 to 6% by weight.

5. The method of claim 1 wherein the rapidly acting contaminant treating composition is a Fenton reagent system.

6. The method of claim 5 wherein the rapidly acting contaminant treating composition comprises a source of an oxidizing agent and a metal catalyst composition.

7. The method of claim 6 wherein the metal catalyst composition is selected from the group consisting of metal salts, iron oxyhydrides, iron chelates, manganese oxyhydrides and combinations thereof.

8. The method of claim 7 wherein the metal catalyst is selected from the group consisting of Fe(II) salts, Fe(III) salts, Fe(II) chelates, Fe(III) chelates and combinations thereof.

9. The method of claim 6 wherein the source of an oxidizing agent is a peroxide.

10. The method of claim 9 wherein the source of the peroxide is selected from the group consisting of hydrogen peroxide, sodium peroxide, calcium peroxide and combinations thereof.

11. The method of claim 10 wherein the source of the peroxide is hydrogen peroxide.

12. The method of claim 6 further comprising stabilizing the source of the oxidizing agent.

13. The method of claim 12 comprising stabilizing the source of the oxidizing agent with a stabilizer selected from the group consisting of acids, salts and mixtures thereof.

14. The method of claim 1 comprising the treating of in situ environment with the rapidly acting contaminant treating composition and the metal permanganate simultaneously.

15. The method of claim 1 comprising treating the in situ environment with the rapidly acting contaminant treating composition and the metal permanganate sequentially.

16. The method of claim 1 wherein the amount of metal permanganate in the in the in situ environment is from about 100 to 1,000 ppm.
